(19) United States
(12) Patent Application Publication
(10) Pub. No.: US 2013/0082876 A1
(43) Pub. Date: Apr. 4, 2013

(54) POSITION MARKING AND REFERENCE METHOD AND SYSTEM FOR THE PRACTICE

(71) Applicant: G. Edzko Smid, Oakland Township, MI (US)

(72) Inventor: G. Edzko Smid, Oakland Township, MI (US)

(21) Appl. No.: 13/632,382

(22) Filed: Oct. 1, 2012

Related U.S. Application Data
(60) Provisional application No. 61/541,486, filed on Sep. 30, 2011.

(51) Int. Cl. G01S 3/02

(52) U.S. Cl. 342/450

(57) ABSTRACT

A method and system are provided for position marking to register precise locations on a stationary objects in space, and to refer back to the locations that same precise location at a later time, while establishing a local coordinate system without consideration for the global location or orientation of the object, thereby ensuring the object does not need to be re-positioned or re-orientated before marking and referring to any object's locations. The problem that a local coordinate reference system based on reference beacons is not correlated to the object's reference frame is addressed through a novel calibration method. By eliminating consideration for coordinate setup and the need to physically move the object in the operating space, a more robust measurement is achieved that replaces such conventional steps with an easy to conduct calibration process that reduces the chance for human error.

### CROSS-REFERENCE TO RELATED APPLICATIONS

This application is a non-provisional application that claims priority benefit of U.S. Provisional Application Ser. No. 61/541,486, filed Sep. 30, 2011 the contents of which are hereby incorporated by reference.

### FIELD OF THE INVENTION

The present invention in general relates to position measurement, and in particular to a method for providing position location measurements of objects.

### BACKGROUND OF THE INVENTION

The Global Positioning System (GPS) is based on the fixed location base stations and the measurement of time-of-flight of accurately synchronized station signature transmissions. The base stations for the GPS are satellites and require atomic clocks for synchronization.

GPS has several draw backs including relatively weak signals that do not penetrate heavy ground cover and/or man-made structures. Furthermore, the weak signals require a sensitive receiver. GPS also utilizes a single or narrow band of frequencies that are relatively easy to block or otherwise jam, and can easily reflect off surfaces, resulting in multi-path errors. The accuracy of the GPS system relies heavily on the use of atomic clocks, which are expensive to make and operate.

Several technologies for precise position tracking systems are available, from laser scanners, to vision, to Radio-Beacon systems, or ultra-sonic range measurement systems. Without loss of generalization, the application of an RF-based positioning system will be used for the remainder of this description. An RF position tracking system such as U.S. Pat. No. 7,403,783 entitled “Navigation System,” herein incorporated in its entirety by reference, employs a target location tracking module that can be setup quickly to provide a coordinate reference system based on current beacon locations.

U.S. Pat. No. 7,403,783 improves the responsiveness and robustness of location tracking provided by GPS triangulation, by determining the location of a target unit (TU) in terrestrial ad hoc, and mobile networks. The method disclosed in U.S. Pat. No. 403,783 includes initializing a network of at least three base stations (BS) to determine their relative location to each other in a coordinate system. The target then measures the time of difference arrival of at least one signal from each of three base stations. From the time difference of arrival of signals from the base stations, the location of the target on the coordinate system can be calculated directly. Furthermore, the use of high frequency ultra-wide bandwidth (UWB) wireless signals provide for a more robust location measurement that penetrates through objects including buildings, ground cover, weather elements, etc., more readily than other narrower bandwidth signals such as the GPS. This makes UWB advantageous for non-line-of-sights measurements, and less susceptible to multipath and canopy problems

However, there exists a need to register precise locations on a stationary object in space, and to refer back to the same precise locations at a later time. Typically, these locations would be referenced in a local coordinate reference frame that is related to the object itself, perhaps matching the reference frame of the blueprint of the object. A problem arises in that a local coordinate reference system based on reference beacons is typically not correlated to the object's reference frame; and as a result, the object must positioned accurately at a specific reference location and at a specific orientation within the local coordinate reference frame before position tracking on the object can take place. Positioning the object in proper location and orientation may be challenging if the object is large, heavy, fragile, immobile or a combination thereof.

Thus, there exists a need for a method and system to register precise locations on a free stationary object in space, and to refer back to that same precise location at a later time, while establishing a local coordinate system without consideration of the global location or orientation of the object, thereby ensuring the object does not need to be re-positioned or re-orientated before marking and referring to any object's locations.

### SUMMARY OF THE INVENTION

A method and system are provided for position marking to register precise locations on a stationary objects in space, and to refer back to the locations that same precise location at a later time, while establishing a local coordinate system without consideration for the global location or orientation of the object, thereby ensuring the object does not need to be re-positioned or re-orientated before marking and referring to any object's locations. The problem that a local coordinate reference system based on reference beacons is not correlated to the object's reference frame is addressed through a novel calibration method. By eliminating consideration for coordinate setup and the need to physically move the object in the operating space, a more robust measurement is achieved that replaces such conventional steps with an easy to conduct calibration process that reduces the chance for human error. A position tracking system is also provided with positioning information in the objects reference frame that is more user friendly for an operator.

Calibration initially utilizes the position tracking information based on the global or local reference beacons (i.e., base stations) to determine the location and orientation of the object within the local coordinate system. The calibration based on GPS or reference beacons is then stored, and used to convert the coordinate system positioning output to a positioning output that is relative to the objects internal reference frame.

### BRIEF DESCRIPTION OF THE DRAWINGS

FIG. 1 illustrates a conversion of local coordinate system positioning to a positioning that is relative to an objects internal reference frame; and

FIG. 2 illustrates a two dimensional representation of position marking according to an embodiment invention.

### DETAILED DESCRIPTION OF THE PREFERRED EMBODIMENTS

The present invention has utility in position marking and referencing to register precise locations on free stationary objects in space, and to refer back to that same precise location at a later time, while establishing a local coordinate system without consideration for the object's global location or orientation, thereby ensuring the object does not need to be re-positioned or re-orientated before marking and referring to any object's locations. The present invention has applications in fields as varied as quality control, forensics, civil engineering structural monitoring, geology, surgery, dentistry, and archaeology. Additional benefits provided by embodiments of the invention include commercial benefits such as labor savings, by eliminating consideration for coordinate setup and physically moving the object in the operating space, a more robust measurement, since eliminating considerations for setup, and replacing them with an easy to conduct calibration process reduces the chances for human error, and finally a position tracking system that provides positioning information in the objects reference frame is more acceptable and user friendly to the operator. The object in certain embodiments is modified in response to the position marking of the object.

Various embodiments of the invention address the problem that a local coordinate reference system based on reference beacons is not correlated to the object's reference frame through a novel calibration method. As part of a local position tracking system, the additional process of calibrating the objects location and orientation will result in a system that exclusively provides positioning information in the object's reference frame. Typically, in circumstances where the local coordinate reference system is not correlated to reference beacons, the object must be positioned accurately at a specific reference location and at a specific orientation within the local coordinate reference frame before position tracking on the object can take place. Positioning the object in proper location and orientation is not always possible and introduces a degree of variability when object movement occurs Object movement is disfavored and even not possible for objects of interest that are large, heavy, fragile, immobile or a combination thereof. Also, there are objects associated with settings such as crime scenes that object movement can compromise the evidentiary value of the object.

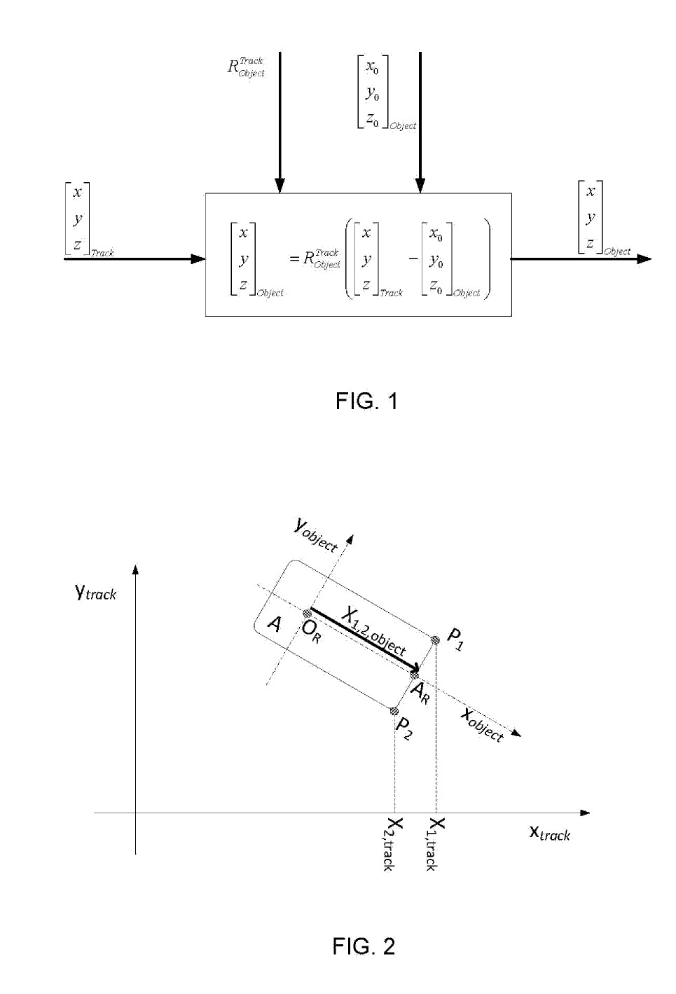

Calibration in certain inventive embodiments initially utilizes the position tracking based on the global or local reference beacons (i.e., base stations) to determine the location and orientation of the object within the local coordinate system. The calibration based on GPS or reference beacons is then stored, and used to convert the coordinate system positioning output to a positioning output that is relative to the objects internal reference frame. The conversion process is a standard 6-dimensional translation and rotation as illustrated in the FIG. 1. With the input of matrices [x y z] _{track}, the scalar R_{Track Object} and [x₀y₀z₀]_{object} (per beacon reference), the object positional value [x y z]_{object} is obtained as an output. It is appreciated that other coordinate systems such as spherical and cylindrical are also operative herein. The amount of translation and rotation is determined by the calibration process. In a 2-dimensional (2D) scenario, the rotation matrix can be determined by the vertical orientation (Yaw, heading or bearing). In a 3-dimensional (3D) scenario, the orientation matrix can be determined by the rotation angles about each of the three axes (roll, pitch and yaw). As used herein “orientation” is used synonymously to describe rotational (2D) matrices and orientational (3D) matrices of object vectoral positions.

In other inventive embodiments, calibration is implemented in two variations. The first more general variation includes the tracking and storing two or three (or more) known locations on the object define object vectoral orientation. Thereafter each known coordinate of the object is associated with a measured position within the local position coordinate reference frame. This information can then be used to determine the required rotation and translation parameters for the object.

FIG. 2 illustrates the calibration of an object “A” in a two dimensional space or pseudo 3D space. During calibration, an operator stores positions P₁ and P₂ as local coordinates of the tracking reference frame, as X_{1, track} and X_{2, track}; respectively and associates them with the known locations (the corners) of the object A. It is appreciated that Y_{track} values also exist for corner points P₁ and P₂. With this information, first the orientation of object A is determined. Since the coordinates of P₁ and P₂ within the objects reference frame are known, the vectoral direction P₁-P₂ can also be determined. Since the locations of P₁ and P₂ were measured in the local coordinate reference frame, a measured direction P₁-P₂ within the local coordinate reference frame is also known. The difference between the measured direction and the direction P₁-P₂ in object A reference frame is now equal to the orientation of the object within the local coordinate reference frame. Once the orientation is known, the object's position coordinate P₁ can be rotated back to the coordinate reference frame, and subtracted from the measured coordinates for P₁. The result is the value for the translation of the object within the local coordinate reference frame. A minimum of two locations on the object are needed to obtain calibration for the 2-dimensional scenario. More locations can be obtained and used to obtain additional information for calibration that can provide redundancy and improve statistical accuracy. It is appreciated that 3D calibration directly follows with collection of a third position.

A second embodiment of the inventive calibration process is a special case of the above described more general inventive procedure. Typically, this case may be used for an object that is aligned in the horizontal plane, but is placed at a random horizontal location at a random orientation. In this case, first the center of the object's internal reference frame O_{R} is marked, and this information is used to translate coordinates from the local reference frame to the objects' internal coordinate system. Secondly, the orientation of the objects' internal reference frame is marked by selecting a point on the X-axis as A_{R}. This information is then used to rotate coordinates from the local reference frame to the objects' internal coordinate system.

The determination of the current tracking location relative to the object's local reference coordinate system can be used to improve tracking accuracy, depending on the operating scenario. The obtained calibration information for the object can be used to determine the beacon locations relative to the object's local reference coordinate system. Depending on the material properties of the object, it may be desirable to eliminate any range measurements that were acquired in the direction of the object, since these measurements are more likely to be non-line-of-sight, and therefore less accurate in terms of range determination. For example, it will be more likely that a range measurement was determined from an indirect path rather than the direct path, if the object or surface is opaque to the frequencies that are used by the RF position tracking system. Similarly, it will be more likely that a range measurement was determined from a direct path, if the measurement was acquired from a beacon that is on the same side as the current tracking location. Effectively, the tracking system may include a level of confidence to each of the measurements, depending on the current relative tracking location and the beacon location relative to the object that is associated with the range measurement.

It should be appreciated that data transfer can be accomplished by direct or wireless connection. A wireless transceiver is provided for communication of the location data to a remote storage device. The position marking data as to the stationary object is particularly useful in determining temporal changes in the object. The transfer of the data to a robotic device subsequently in proximity to the object allows for subsequent and efficient evaluation of the object. A device for doing so is detailed in a co-filed application entitled “TARGET LOCATION POSITIONING METHOD AND DEVICE” that claims priority benefit of U.S. Provisional Application Ser. No. 61/541,529, filed Sep. 30, 2011.

Depending on the material properties of the object, it may be desirable to eliminate any beacon inputs that were acquired in the direction of the object that are likely to be non-line-of-sight, and therefore less accurate in terms of range determination. For example, it will be more likely that a range measurement was determined from an indirect path rather than the direct path. With the knowledge of the current orientation and position, and with knowledge of the beacon locations for tracking, the system will be able to determine the direction of each of the range measurements to each of the beacons, and add a level of confidence to each of the measurements, depending on the reasonable estimation of the relative location of the object or surface to the handheld location measurement device.

The foregoing description is illustrative of particular embodiments of the invention, but is not meant to be a limitation upon the practice thereof. The following claims, including all equivalents thereof, are intended to define the scope of the invention.

1. A method for position marking of an object, said method comprising:
(a) calibrating position tracking information and direction on the object from global or local reference beacons to yield an object internal coordinate frame reference;
(b) obtaining local coordinates for two or more points (P₁, P₂ . . . P_{N}) on the object from the object internal coordinate frame reference to yield an obtained position location information for the object;
(c) determining a direction of orientation from the two or more points for the object to yield a determined direction of orientation of the object; and
(d) calculating a translation value of the object between the determined direction of orientation of said object and the obtained position location information for the position marking of the object.

2. The method of claim 1 wherein a minimum of two points of location on the object are needed to obtain calibration for a 2-dimensional object.

3. The method of claim 1 wherein the object internal coordinate frame reference is generated without global location or orientation of the object.

4. The method of claim 1 wherein the object internal coordinate frame reference is generated without moving of the object.

5. The method of claim 1 wherein the object internal coordinate frame reference is generated with said global or local reference beacons having line of sight to the object.

6. The method of claim 1 wherein the position tracking information and direction is converted to the object internal coordinate reference frame using global positioning satellite (GPS) reference beacons.

7. The method of claim 1 further comprising repeating the method steps of (a), (b), (c), and (d) at a later time to determine temporal movement of the object.

8. The method of claim 1 wherein the step (d) satisfies the expression
[x y z]_{object}=R_{Track Object}([x y z]_{track}−[x₀ y₀ z₀]_{object})
where R_{Track Object} is the position tracking information and direction of the object, [x₀ y₀ z₀]_{object} is an initial position of the object from the object internal coordinate frame reference, and [x y z]_{track} is the translation value.

9. The method of claim 8 further comprising transferring [x y z] _{object}, or set of R_{Track Object}, [x y z]_{track}, [x₀ y₀ z₀]_{object}, or a combination thereof to a data storage device.

10. The method of claim 9 wherein the transferring step is wireless.

11. The method of claim 9 wherein the transferring step is to a robotic device subsequently in proximity to the object.

12. The method of claim 1 wherein the object is a man-made structure.

13. The method of claim 1 wherein the object is positioned in a crime scene or archaeological site.

14. The method of claim 1 wherein the object is a geologic feature.

15. The method of claim 1 wherein the object is an anatomical feature.

16. The method of claim 1 wherein the two or more points relate to a center internal reference frame of the object.

17. The method of claim 1 further comprising modifying the object in response to the position marking of the object.
